(19) United States
(12) Patent Application Publication
(10) Pub. No.: US 2007/0091488 A1
(43) Pub. Date: Apr. 26, 2007

(54) Optical element mount

(76) Inventors: Yuri Grapov, Park City, UT (US); David Owen, West Jordan, UT (US); Allen H. Tanner, Sandy, UT (US)

Correspondence Address: THORPE NORTH & WESTERN, LLP., 8180 SOUTH 700 EAST, SUITE 200, SANDY, UT, 84070, US

(21) Appl. No.: 11/255,583

(22) Filed: Oct. 21, 2005

(51) Int. Cl. G02B 7/182

(52) U.S. Cl. 359/876

(57) ABSTRACT

An optical element mount, including an outer body and an inner positionable body positionable with respect to the outer body in X, Y, and Z directions, and rotatable about at least X and Y axes and configured to carry the optical element, and adjustment members carried by and supported by the outer body and selectively moveable with respect to the outer body and at least one biasing element configured to bias the inner positionable body against the adjustment members; whereby the inner positionable body can be adjusted in position in three axes and in tilt about at least two axes.

### BACKGROUND

In optical systems it is often desirable to have an optical element, such as a mirror, prism, or lens, mounted so as to be precisely positionable. Moreover, it is often required that both considerable range in adjustment and precision in adjustment be provided. These two goals, when presented to a mounting designer trying to design a mounting that is also simple and low-cost, are inherently at odds with each other. Typically the provision of considerable range of motion can be at the expense of precision in placement and retention of the optical element at a particular place and directional attitude.

Moreover, it is often desirable to provide adjustment in as many planes and rotational axes as possible. Again this design goal typically is at odds with the goals of providing precision and stability over time and condition changes, as well as making the mount simple and less costly.

### SUMMARY

The inventors have recognized that it is desirable to provide a stable optical element mount that is translationally adjustable as to position in the x, y and z orthogonal directions and is rotationally adjustable as to tilt in at least 2 of the x, y, and z orthogonal rotational axes. Briefly, and in general terms, the invention accordingly provides an optical mirror mount comprising an outer body and a positionable inner mount body adjustable with respect to the outer body in the x, y and z directions, and at least two of the x, y and z rotational axes; the inner positionable mount body being configured to carry an optical element.

In a more detailed aspect, the outer body can define an opening for enabling the optical element to be accessible to a photonic stream, and the inner positionable mount body can be carried by the outer body via fine adjustment elements and elastic retaining elements; the latter providing stabilizing restoring forces biasing the inner positionable mount body against the fine adjustment elements.

### BRIEF DESCRIPTION OF THE DRAWING FIGURES

Further features and advantages of the invention will be appreciated with reference to the following detailed description of example embodiment(s), taken in conjunction with the accompanying drawing figures illustrating same, wherein:

FIG. 1 is a top view of an optical system for shifting the wavelength of a photonic stream using a number of optical elements in optical mounts in accordance with one example embodiment of the invention, which illustrates an example use environment of the invention;

FIG. 2 is an exploded orthogonal view of one of the mounts shown in FIG. 1 illustrating a relationship to three orthogonal axes, i.e. X, Y and Z-axes, the Z-axis being aligned with an optical axis in the illustration of an example embodiment;

FIG. 3 is an upper left front orthogonal view of the mount shown in FIG. 2, again illustrating a relationship to X, Y, and Z orthogonal axes, the Z axis being aligned with the optical axis in the figure; and

FIG. 4 is an upper left front orthogonal view of an optical mount in another example embodiment, here an optical axis being parallel with the X-axis.

### DETAILED DESCRIPTION OF EXAMPLE EMBODIMENT(S)

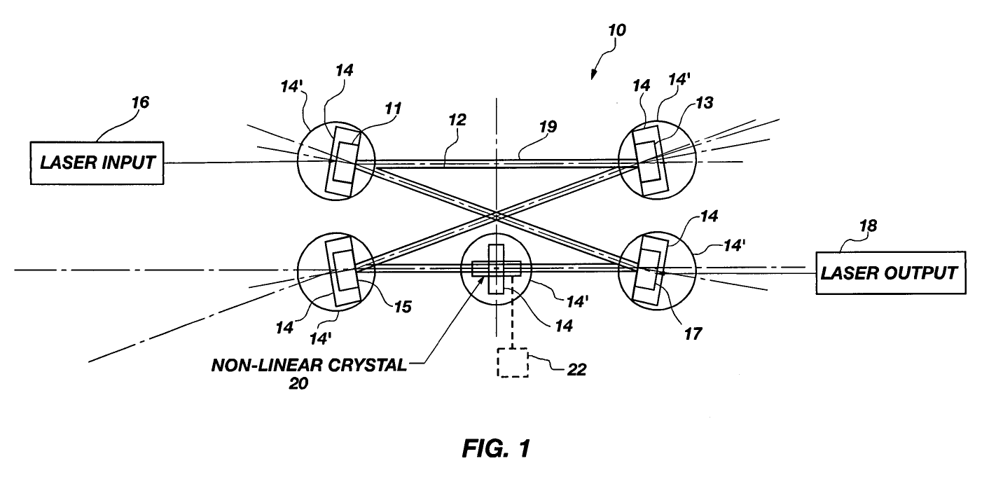

With reference to FIG. 1 of the drawing figures, in one example application of the invention an optical system 10 configured for enhancement and alteration of the wavelength of a photonic stream of light 12 includes a plurality of optical elements, which in this example are mirror elements 11, 13, 15, 17. Some of the mirrors can be conventionally configured to reflect certain wavelengths of light and pass certain wavelengths of light. The mirror elements are carried by optical element mounts 14, which in turn are carried on bases 14′. In the illustrated example, precise alignment of a laser photonic stream input 16 with a photonic stream output target 18 and with a non-linear crystal 20, as well as the four mirror elements mentioned is required for proper functioning of the system 10, sometimes referred to as a “bowtie” enhancement system.

The system 10 can include manual or automated means 22 for adjusting the directional attitude of the non-linear crystal 20. For example the mount 14 can be adjusted as described below, and/or further adjustment can be interposed between the mount and the crystal, so that once the lattice of the crystal has been precisely aligned using the mount's adjustment capability, further deflection of a controlled nature can be done to move the element into a selected attitude difference with respect to the photonic stream 12.

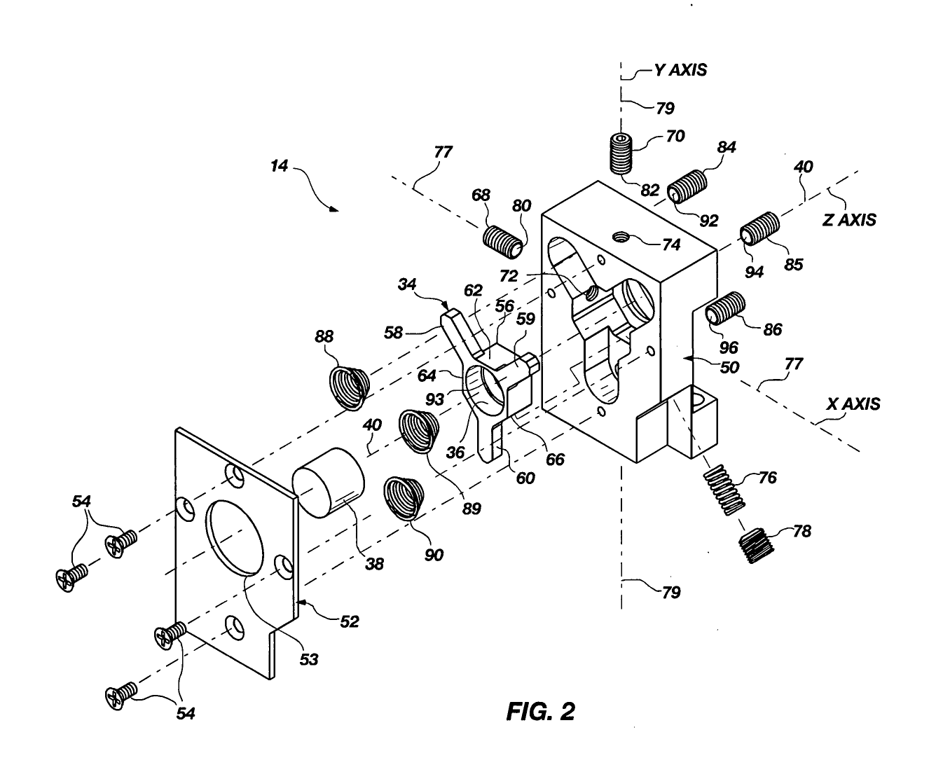

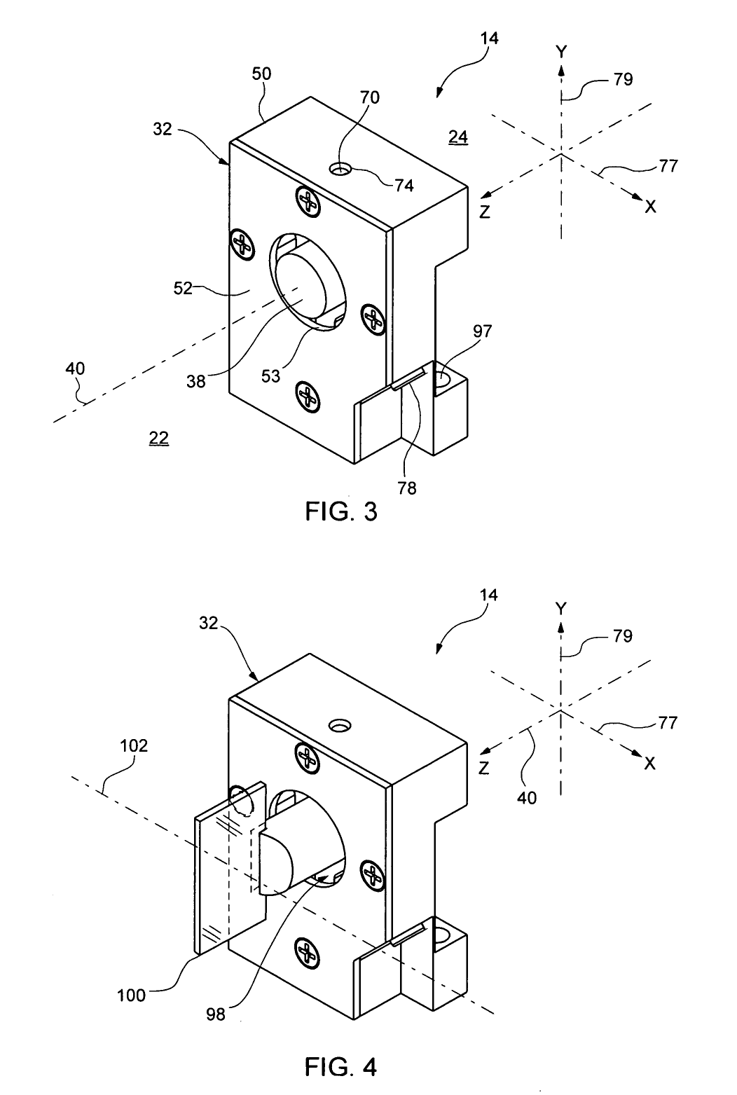

With reference to FIGS. 2 and 3, and turning to the discussion of mountings 14 more particularly, an optical element 11 mounting includes an outer body 32 and an inner positionable body 34 carried therein. The inner positionable body member includes a receptacle 36 configured for holding an optical element 38. In the example embodiment this can be a mirror, such as one of those mentioned above. In the illustrated embodiment the optical axis 40 is essentially the same as a Z-axis of the mounting. Moreover in one example embodiment the inner positionable body, as well as the outer body it is carried within, can include front and back openings (not shown) to allow light to pass entirely through the mount. In conventional (e.g. non-dichoric) mirror applications, and in applications in which the optical element is carried entirely outside the outer body (e.g. such as that shown in FIG. 4), only one opening through the outer body is needed. In the illustrated embodiment the mount is for a mirror, but it will be appreciated that it can be configured so that light can pass through the mounting from a first side 22 to a second side 24 along the optical axis 40 by providing holes (hidden behind other structure in the figures) in the back side 24 of the inner positionable body 34 and the back side of the outer body 32.

For ease of assembly, the outer body 32 can be formed in two parts. In the illustrated example these are a holder 50 and a cover 52. The cover includes an opening 53 to accommodate light access to the optical element 38 in the illustrated embodiment, or for the inner positionable body 34 to pass through if the optical element is carried outside the outer body (not shown in the figure, but e.g. such as is shown in FIG. 4). In another example embodiment, a different configuration can be provided, e.g. a clamshell arrangement (not shown) separating along the direction of the optical axis 40 in the figure at a plane perpendicular to it. Another configuration for the outer body different from that of the illustrated embodiment of the outer body member can be used, provided it allows convenient constructability and has the same functionality when assembled as that shown by way of example.

In the illustrated embodiment including a holder 50 and cover 52, threaded fasteners 54 hold the cover to the holder. This is done after other structure shown has been placed inside. With the fastening of the cover to the holder, they work together to form the outer body 32 of the mount 14 of the illustrated embodiment.

The inner postitionable member 34 has a central portion 56 and three outwardly extending arms 58, 59, and 60. In the illustrated embodiment one of said arms 60 is aligned with the Y-axis. The others (58, 59) are each disposed at an oblique angle to one of the X & Y axes, e.g., at an angle between 15 and 75 degrees, such as at 45 degrees. The central portion has a horizontal bearing surface 62 and a vertical bearing surface 64 and a bearing surface 66 disposed obliquely to the previously mentioned vertical and horizontal surfaces. In the illustrated embodiment the obliquely disposed surface 66 is oriented at an angle inclined between 15 and 75 degrees, such as 45 degrees, from each of the vertical and horizontal bearing surfaces, (and the X & Y axes).

These horizontal and vertical bearing surfaces 62, 64 are biased against horizontal and vertical position fine adjustment elements, which in the example are threaded set screws 68, 70 respectively, which turn trough fine-threaded openings 72, 74 respectively, in the holder 50 of the outer body 32. This biasing is accomplished by means of an X/Y position biasing spring 76, which bears against the obliquely disposed bearing surface 66. The spring tension is adjustable by a threaded setscrew 78, which is threadably received in the holder element of the outer body. This arrangement allows adjustment in position of the inner positionable member up and down, and right and left, in a Z-plane (orthogonal to the Z axis, which in the figures is parallel to or coaxial with the optical axis 40, as mentioned) and along X and Y axes (77, 79, respectively) as shown.

In one embodiment, the inner tips 80, 82 of the fine adjustment element screws are given a rounded or domed configuration. This reduces inter-adjustment cross talk, i.e. unintentional movement in one direction or about one axis when position or tilt with respect to another is being adjusted.

The three outwardly extending arms 58, 59, 60 of the inner positionable body 34 are used in tilting adjustments, and in positioning of the inner positionable body in the Z direction, i.e., along the Z axis (optical axis) 40 in the figures. They are each biased against Z/tilt fine adjustment element screws 84, 85, 86, respectively, by Z/tilt biasing springs 88, 89, 90 respectively. Again, tip portions 92, 94, 96 of these fine adjustment elements can also be given a rounded/domed configuration in one embodiment, again to reduce adjustment cross talk. All of these fine adjustment screw elements are threadably received through the holder portion 50 of the outer body 32 by finely threaded openings found therein (hidden behind other structure in the view). The biasing springs 88, 89, 90 are retained against the arms by the cover 52 of the outer body 32 discussed above.

It will be appreciated that by turning each of the Z/tilt fine adjustment screws 84, 85, 86 in the same direction of rotation the Z position of the optical element 38 carried by the inner positionable body 34 can be adjusted. By turning them differentially with respect to each other, the tilt of the optical element with respect to the X, Y and Z-axes 77, 79, 40, respectively, can be adjusted. These adjustment screw elements adjust by rotation about, and adjust rotational position with respect to, the X and Y axes in the figure. In one embodiment, such as that illustrated, the tilt of the optical element with respect to the Z-axis 40 can be adjusted by rotating it with respect to the inner positionable body 34. In the illustrated embodiment this can be accommodated by a round shape aspect of the optical element and the receptacle 36 that receives it. In one embodiment an elastomeric O-ring 93 in a groove in the receptacle firmly holds the optical element 38 preventing unintentional movement, but can accommodate rough adjustment along the Z-axis and rotation about the Z-axis. In another embodiment a further intermediate element (not shown) can be provided which is adjustably rotatably carried by the inner positionable body and which in turn carries the optical element, providing rotational adjustability about the Z-axis. As will be appreciated, most optical elements are essentially symmetrical about the Z (optical) axis and thus generally do not require adjustment in this respect. However, this feature can be provided as mentioned herein in one example embodiment if this additional functionality is desired.

With reference to FIGS. 1 and 3, the outer body 32 can include mounting holes (e.g. 96) to facilitate attachment to a base (e.g. 14′ in FIG. 1). Such a base, in the illustrated embodiment, can provide rough adjustment with respect to supporting structure (such as a table or housing, not shown) that is carrying and supporting the optical system 10.

With reference to FIG. 4, it will be appreciated that other example embodiments can be provided as modifications can be made, for example an inner positionable body 98 can be configured so that an optical element 100 is carried outside the outer body 32 of the mount 14. In one embodiment the optical axis 102 can be other than the Z-axis 40.

It will be appreciated that an optical element mount 14 in accordance with the invention can provide a solution to the problems of providing precision of adjustment with a relatively large range of adjustment in X, Y, and Z directions and at least two of 3 rotational directions in a mount of relatively simple (i.e. less costly) configuration.

While one or more example embodiment(s) have been described herein with particularity, it will be appreciated that numerous changes can be made within the purview of ordinary skill in the art, and without the exercise of inventive faculty. It is not intended that the scope of the invention be limited by the example(s) set forth herein.

1. An optical element mount, including:
an outer body;
an inner positionable body, translationally positionable with respect to the outer body in X, Y, and Z orthogonal directions, and rotatably positionable about at least X and Y orthogonal rotational axes, and configured to carry the optical element;
a plurality of adjustment elements carried by and supported by the outer body and selectively moveable with respect to the outer body;
a biasing element configured to bias the inner positionable body against the adjustment elements;
whereby the inner positionable body can be adjusted in position along three orthogonal axes and in tilt rotationally about at least two orthogonal axes; and
wherein the inner positionable body has outwardly extending arms, the outwardly extending arms being coplanar with a horizontal bearing surface of the inner positionable body.

2. An optical element mount as set forth in claim 1, wherein the outer body is mountably configured for facilitating on a base.

3. An optical element mount as set forth in claim 1, wherein the inner positionable body is configured to facilitate rotation of the optical element with respect to the inner resistible body.

4. An optical element mount as set forth in claim 1, wherein the mount includes a biasing element for holding position in the X and Y directions, and at least one biasing element for holding a tilt position.

5. An optical element mount as set forth in claim 1, wherein the outer member further comprises a holder and a cover.

6. An optical element mount as set forth in claim 1, wherein the adjustment members have inner portions that are rounded.

7. (canceled)

8. An optical element mount as set forth in claim 1, wherein the inner posititionable body has at least two bearing surfaces disposed orthogonally to each other.

9. An optical element mount as set forth in claim 1, wherein the adjustment members further comprise threads and are threadably received by the outer body.

10. An optical element mount, including:
an outer body configured to be stably supported by a base;
an inner positionable body, which is translationally positionable with respect to the outer body in X, Y, and Z directions, and rotatably positionable about at least X and Y axes, and configured to carry the optical element;
a plurality of adjustment screws threadably received in the outer body and in contact with the inner positionable body and configured to facilitate adjustment of the inner positionable body with respect to the outer body;
at least one biasing element configured to bias the inner positionable body against the adjustment screws;
whereby the inner positionable body can be adjusted in position in three axes and in rotation about at least two axes; and
wherein the inner positionable body has outwardly extending arms, the outwardly extending arms being coplanar with a horizontal bearing surface of the inner positionable body.

11. An optical element mount as set forth in claim 10, wherein the outer body further comprises a plurality of elements which are attached together.

12. An optical element mount as set forth in claim 11, wherein the outer body includes a holder which carries the adjustment screws, and a cover.

13. An optical element mount as set forth in claim 12, wherein the cover restrains at least one biasing element.

14. An optical element mount as set forth in claim 10, comprising a plurality of biasing elements.

15. (canceled)

16. An optical element mount as set forth in claim 10, comprising a plurality of adjustment screws, and wherein the inner positionable body contacts an adjustment screw adjusting position of the inner positionable body at a location inward of a location where the inner positionable body contacts an adjustment screw adjusting tilt of the inner positionable body.

17. An optical element mount as set forth in claim 16, wherein the inner positionable body comprises an X position bearing surface and a Y position bearing surface, each contacting an adjustment screw, and a biasing element biasing the inner positionable body in a direction disposed at an oblique angle to both of said bearing surfaces.

18. An optical element mount as set forth in claim 17, further comprising three adjustment screws that each adjust Z position and tilt of the inner positionable body with respect to the outer body.

19. An optical element mount as set forth in claim 10, wherein the outer body defines an opening configured so that the inner positionable body can carry the optical element at a location accessible by light.

20. An optical element mount as set forth in claim 19, wherein the outer body defines a plurality of openings so that light can pass through said mount.

21. A mount for an optical element, comprising:
an outer body member configured to be supportable on a base;
an inner body configured to be positionally and tiltably adjustably carried by the outer body member, and to carry the optical element;
wherein the inner positionable body has outwardly extending arms, the outwardly extending arms being coplanar with a horizontal bearing surface of the inner positionable body;
a plurality of adjustment screws configured for contacting and moving the inner body with respect to the outer body in three ordinal directions and about at least two rotational axes; and
a plurality of biasing members configured for biasing the inner member against the adjustment screws.

22. An optical element mount as set forth in claim 21, wherein the optical element comprises an arcuately-shaped mirror.

23. An optical element mount as set forth in claim 22, wherein the mount is usable for alignment of laser light.

24. An optical element mount as set forth in claim 21, wherein the optical element is rotationally positionable with respect to three ordinal rotational axes.
